(19) United States
(12) Patent Application Publication
(10) Pub. No.: US 2004/0086093 A1
(43) Pub. Date: May 6, 2004

(54) VoIP security monitoring & alarm system

(76) Inventor: Paul Steven Schranz, Bowen Island (CA)

Correspondence Address: Paul Steven Schranz, 1270 Oceanview Rd, Box G30 RR1, Bowen Island, BC, V0N 1G0, CA

(21) Appl. No.: 10/694,678

(22) Filed: Oct. 29, 2003

Related U.S. Application Data
(60) Provisional application No. 60/421,849, filed on Oct. 29, 2002.

(51) Int. Cl. H04M 11/04

(52) U.S. Cl. 379/37; 340/531

(57) ABSTRACT

The present invention deals with a Voice/Video over IP (VoIP) security monitoring and alarm system. I claim the priority of provisional patent application 60/421849 submitted Oct. 29, 2002. The system includes a plurality of peripheral devices located around a building that communicate bi-directionally with a system control module (SCM). The SCM is connected to the Internet via ADSL or Cable modem, or by cellular phone with a Bluetooth interface. The peripheral devices detect an event and notify the SCM, the SCM establishes a VoIP call to a remote user in the Internet, PSTN or cellular networks. The remote user using a multimedia device will hear ambient audio and see video images from the peripheral device in the location of the alarm. The remote user issues DTMF commands to the SCM to control the audio, initiate conference calls and other functions. The call transfers without being interrupted between peripheral devices based on detection of events. Email and Instant Messaging notification are also used.

The present invention relates to a residential, commercial or industrial security monitoring and alarm system. I claim the priority of provisional patent application No. 60/421849 submitted Oct. 29, 2002. In this particular invention, a plurality of peripheral devices communicate with a system control module (SCM). Upon detection of an event the system establishes a Voice/Video over Internet Protocol (VoIP) call to a remote user or monitoring service. Using VoIP technology leverages several inherent advantages related to IP packet networks. A VoIP call is one that uses a VoIP call signalling protocol to set up a call and a VoIP transport protocol to deliver the payload (audio and video information). Examples of VoIP call signalling protocols include, but are not limited to, the Session Initiation Protocol (SIP) from the Internet Engineering Task Force (IETF) and H.323 from the International Telecommunications Union (ITU). An example of a VoIP transport protocol includes, but is not limited to, the Real-Time Transport Protocol (RTP) from the IETF.

### BACKGROUND INFORMATION AND PRIOR ART

The security monitoring and alarm industry is well established in their practices of monitoring buildings in residential, commercial and industrial settings. They use wireline and wireless systems in which a plurality of sensors, cameras and audio monitors communicate over bi-directional links to a system controller, which itself communicates to a remote central control station, or monitoring service, via a wireless or wireline channel. The sensors, cameras and audio monitors are deployed in specific regions called zones that they monitor. There may be a one to many relationship between the cameras or audio monitors and the sensors. These sensors come in many varieties, such as motion, vibration, smoke or heat detectors. A multitude of CCTV cameras are used with varying features: black & white, colour, infrared, NTSC, PAL, low resolution, high resolution. The audio monitor is some arrangement of microphones, which can be incorporated with the camera, and some audio processing electronics. The wireline link is typically twisted pair copper wire or coaxial cable; the wireless link is in the 800 MHz, 900 MHz or 2.4 GHz range. The system controller communicates with a remote central control station using methods such as wireless and cellular links, traditional Plain Old Telephone Service (POTS) over the Public Switched Telephone Network (PSTN) and in some cases proprietary techniques over the Internet. Various techniques exist to capture and record video and audio images, most notably the VCR and solid-state memory.

When a sensor detects an event it notifies the system controller, which initiates a general or silent alarm, and/or the recording of video and audio information. The general alarm is typically a siren. The silent alarm may be a remote notification to a monitoring service, such as a telephony call set-up in the traditional PSTN network or a wireless network, or some form of proprietary notification via the Internet. In general the remote notification is a pre-recorded message. No continuous, real-time audio information from the area of event detection is transported to the remote user; similarly, no continuous, real-time audio information from the remote user is transported to the area of event detection. There are systems using ISDN connections over the PSTN to deliver real-time audio and video information between the secured premises and the central control station.

There are some doorbell monitoring systems that can be enabled to set-up a telephony call to a predefined set of numbers upon actuation of the doorbell button. These systems invariably use the traditional PSTN network to set up a POTS call. It is difficult and expensive to expand these types of systems to include a plurality of peripheral devices due to the inherent technology involved in interfacing to the PSTN. Furthermore, data services are not available over the communication link between the caller and callee.

There are a number of existing patents relating to the activation of a telephony POTS or ISDN call on the PSTN after a trigger event, some of which employ a plurality of wireless and wireline devices.

The U.S. Pat. No. 5,736,927, discloses a system wherein alarm sensors interact with a system controller over hardwired or wireless links; audio monitors with microphones are coupled via twisted pair wire to an audio controller that is also hardwired to the system controller. The system allows recording of 6-8 seconds of audio before an alarm and 6-8 seconds of audio after an alarm. The system allows a central station to call in and engage in half-duplex communication with an alarm site for a predefined period of time. This system uses the PSTN to place a call between the system controller and the central control station. This system does not allow full-duplex communication between the central station and the alarm site. This system uses twisted pair wiring between each audio monitor and the audio controller and between the speakers and audio controller.

The U.S. Pat. No. 6,452,490, discloses a system for communicating between Customer Premises Equipment (CPE), alarm sensing devices, and alarm monitoring stations. The sensing devices communicate with an end office switch by transmitting a message, such as Dual-Tone Multi-Frequency (DTMF) digits to that switch. At the switch, the message is processed and a determination is made of which of a plurality of alarm monitoring stations should receive the alarm indication. The system attempts to over come the need for a large number of trunking lines at the alarm monitoring station by sending brief data packets containing alarm information of several events. Never is there any real-time audio or video information exchanged between the customer premises and the alarm monitoring station. If Voice/Video over IP technology is utilized the need for multiple trunking lines is eliminated since one network connection can handle multiple calls simultaneously.

The U.S. Pat No. 6,067,346, discloses a system for providing redundancy for security systems served by the public switch telephone network (PSTN) that includes a cable modem interconnected to a security system controller. This system requires special equipment at a Central Office to detect abnormal line conditions on the local loop to the customer premises. Mention is made of using a cable modem and packet data network to provide redundancy in case the local loop from the Central Office is disconnected. In the advent of a disconnected local loop, the system would send an alert message via the cable modem over a packet data network. The cable modem can also be connected to a video camera or microphone located at the secured premises so that a video or audio feed to the central monitoring service may be provided via the packet data network. Unfortunately, this patent does not offer any method or description of how this is accomplished. Also, this system only provides simplex, non-real time video and audio feed via the packet data network. It does not provide real-time, bi-directional (full-duplex) audio communication between the monitoring station and the secured premises. It also does not provide real-time video communication. In both cases, the audio and video is delayed by the transport through the packet data network.

The U.S. Pat No. 6,429,893, discloses a system for monitoring and recording activity within the range of a proximity detector. The system enables an occupant of a house or building to communicate orally with a person who approaches a door or other threshold either through means disposed at the door or other threshold or remotely. The remote communications is carried out via a wireless link using wireless transceivers and antennas at both ends. This system is limited in operational use by the fact that the remote user must be in range of the wireless communications. A telephone line also provides data message services via a modem. Sending video and audio data over a conventional dial-up modem is extremely slow for video and choppy for audio. Real-time communications are simply not possible.

The U.S. Pat. No. 6,091,771, discloses a system that provides real-time video and audio data between a customer premises and a central monitoring station via an ISDN conduit. This is an advanced system used by a monitoring service. It employs a plurality of sensors, a plurality of video cameras, a site control unit, an alarm unit and a terminal adapter at the customer premises. A significant amount of proprietary equipment must be installed at the customer premises to process the video feeds. The system uses two POTS lines that are configured for ISDN operation. Although there is a bandwidth improvement over normal analog POTS lines, the data rate is still significantly slower than what is possible using ADSL or Cable modems connected to an IP network.

A number of shortcomings are inherent in the previous systems as outlined below. These limitations pertain to two distinct uses of security system, namely those that notify a monitoring service and those that notify an individual, such as the owner of the secured premises.

When the security system contacts an individual upon alarm it attempts to establish a call. When this call is to be established using the existing PSTN a set of telephone numbers pre-programmed in the system are to be dialled. These numbers are dialled one at a time until an answer is reached. This method is inefficient and wastes time during an alarm situation and the resources of the telephone network. What if the individual is not available on any of the pre-programmed telephone numbers, for example, they are in a meeting and do not wish to be disturbed with an intrusive telephone call (and this includes cell phones in vibrate mode). Unless an expensive full-time monitoring service is employed, it is entirely possible that an emergency call could go unheeded.

In the information age, people may have many devices they use for communications, for example: work phone, home phone, cell phone, email, pager, fax, PDA (Palm), laptop, and desktop. Clearly no solution has been provided yet for a security system to make contact on the first attempt with the correct device, the one at which the user can be reached. Also, the preferences of the individual being contacted may change. They may desire to be contacted in a certain way, for example, while in a meeting they may prefer an Instant Message on their laptop, while at their office desk the work phone, while on the road their cell phone. Similarly, an operator at a security monitoring service would also prefer varying forms of first contact depending on the current call load. No mechanism exists in a security system to dynamically adjust to user preferences. Furthermore, the security system is not notified dynamically of the presence of the user. Security systems available today that use the PSTN or cellular networks lack user, or personal, mobility.

During an alarm situation the security system attempts to contact an individual. Once the call is established it is not possible for the notified agent to initiate a conference call with another party, such as the police or a friend in the neighbourhood. It would be beneficial for the user to place a conference call to a third-party without losing real-time contact with the alarm situation. Again, unless a full-time monitoring service is employed, this service is unavailable. Even in the case of a monitoring service, the ability to simultaneously listen in on the alarm call and conference in a 3^{rd} call leg is beneficial and improves the ability of the monitoring operator to keep abreast with the alarm situation.

For both professional and private security systems the exclusive use of wireless networks and PSTN have limitations. In the case of wireless networks the user may be out of range of the serviceable area, but chances are there would still be Internet or PSTN access. Using the PSTN may result in expensive long distance charges if the call placed by the security system is out of the local toll area. Routing the call across the Internet backbone can save significantly on the cost of the call. What is lacking in these security systems is again user and network mobility.

When the security systems notifies a monitoring service, the use of the PSTN for alarm delivery has a significant infrastructure cost associated with it. If the call center for a monitoring service is servicing a large client base, there will be excessive infrastructure cost associated with renting high-speed digital PSTN connections, like T1/E1 or T3/E3. Further costs include a PBX, wiring, BIX wiring cabinet and from time to time restructuring costs. A call center enabled to receive VoIP calls can significantly reduce this cost by employing IP phones, an Ethernet hub, a single LAN and high-speed Internet connections. As an example, a single 640 kbps DSL or Cable modem connection can theoretically handle up to 10 simultaneous VoIP calls on a single twisted. In fact, it is common to find DSL and Cable modems that have a down stream data rate of between 6-7 Mbps. This translates into a single modem at a call center handling up to 100 VoIP calls. Note that the price of a T1/E1 or T3/E3 PSTN connection is significantly higher than a high-speed Internet connection and can not handle as many simultaneous calls.

These systems do not employ continuous real-time monitoring using polling because of the need to establish a PSTN circuit. Hence a third party monitoring service cannot be certain that the communication channel between the service and the monitored premises is alive and well in real-time. Although systems exist to detect if the local loop (the two wire connection to the monitored premises from the Central Office) is tampered with, none can detect immediately if there is a failure somewhere else in the PSTN.

These security systems do not provide a sophisticated web management portal for the user, which can be accessed via any device connected to the Internet that provides a secure web browser that uses protocols like https, ftp, XML etc.

### SUMMARY OF THE INVENTION

In light of the foregoing disadvantages inherent in the known types of security systems now present in the prior art, the present invention provides a new security system architecture and paradigm wherein the increased level of functionality provided removes the limitations of the past prior art.

The general purpose of the present invention, that shall be described subsequently in great detail, is to provide a new security system apparatus and method that has many of the advantages of the security systems mentioned previously and many novel features that result in a new security system which is not anticipated, rendered obvious, suggested, or even implied by any of the prior art security systems, either alone or in any combination thereof.

It is a primary object of the present invention to overcome the disadvantages of the prior art by utilizing the Internet and VoIP technology in a security system that uses a network of advanced peripheral devices in concert with a system control module.

It is a further object of the invention to provide a system utilizing advanced peripheral devices that have a number of functions including sensing, actuating, video and audio monitor and communications interfacing. The current invention includes a plurality of these peripheral devices located at strategic points exterior and interior to a building or monitored premises. These devices communicate via a wireless or wireline connection to a system control module located on premises.

It is a further object of this invention to provide a system control module (SCM) that connects to the advanced peripheral devices in a wireline or wireless manner and to the Internet via ADSL, Cable, or Dial-Up modem or by using a cell phone connected to the SCM via Bluetooth. The SCM has computing resources to run the system control algorithm and other processing algorithms necessary for the function of the present invention.

Once a peripheral device detects an event it notifies the SCM, which then initiates a VoIP call to a remote agent using a pre-programmed VoIP uniform resource locator (URL). The use of VoIP requires a VoIP service provider. This VoIP call can reach a user in the IP network using an IP enabled communication device such as a VoIP phone or multimedia computer, or by going through a gateway it can terminate on a traditional POTS or cellular phone. The SCM then routes the audio and/or video data from the peripheral device to the remote agent.

It is a further object of this invention during alarm detection to locate and connect with the notified agent as quickly as possible using VoIP address resolution and VoIP presence protocols. In fact, it is expected to reach the user on the first attempt if the user is available to be reached.

It is a further object of this invention to provide auto-call back on presence when the unavailable remote user registers as available.

It is a further object of the present invention to provide the notified agent with remote control of the audio path in either direction by sending DTMF commands to the SCM. The notified agent can adjust the volume up or down or disable the audio path, both features in either direction independently.

It is a further object of this invention to provide tele-conferencing features once the VoIP call is established. The notified agent can ‘invite’ other people into the alarm call by issuing DTMF commands to the SCM, which in turn uses VoIP call signalling to request a conference with a third-party. A conferencing bridge software module running on the SCM, or perhaps elsewhere in the IP network, is used to provide the necessary audio processing in conferencing applications.

It is a further object of this invention to provide real-time intruder tracking by monitoring the current location of the intruder using the advanced peripheral devices and motion sensors. The notified agent is kept up to date with the current location by periodic announcements from the SCM or by querying the SCM using DTMF commands.

It is a further object of this invention to provide dynamic call transfer between peripheral devices when the intruder moves from zone to zone. In this case, audio is only received from and sent to the current location.

It is a further object of this invention to provide zone override and allow the notified agent to command a call transfer to a particular peripheral device.

It is a further object of this invention to provide an audio and video recording mechanism that uses a hard disk drive to store the data in real-time using standard audio and video formats.

It is a further object of the invention to provide pre-recorded audio playback at a peripheral device with an announcement stored on the SCM. Typical examples include a doorbell chime, attack dogs barking or the speech of a person.

It is a further object of this invention to allow multiple VoIP calls to take place simultaneously, each between a peripheral device and a remote endpoint in the Internet, PSTN or cellular network.

It is a further object of this invention to provide a third-party monitoring system that exists in the Internet for polling the availability of the security monitoring and alarm system. In the case of a polling failure, an agent would be notified by the third-party.

It is a further object of the invention to provide a remote, secure web management portal via a web application running on the SCM. This portal is used to monitor the current configuration and system status and provide a command and configuration interface.

It is the last object of the invention to reduce the infrastructure costs of monitoring service call centers by providing a VoIP security system that establishes calls over the Internet. Under this architecture, the call center exists in the Internet domain. This allows the call center to replace the existing PSTN technology (analog/digital phones, two-wire cabling, PBX, T1/E1) with Internet technology (IP phones, Ethernet cabling, hub, PC, high-speed Internet connection).

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent construction insofar as they do not depart from the spirit and scope of the present invention.

### BRIEF DESCRIPTION OF THE DRAWINGS

In the drawings which illustrate by way of example only a preferred embodiment of the invention,

FIG. 1 is a network diagram of a simplified version of the security monitoring and alarm system and the VoIP, PSTN and Cellular networks.

FIG. 2 is an expanded block diagram view of the peripheral devices and system control modules.

FIG. 3 is a perspective networking arrangement of a plurality of peripheral devices and the system control module.

FIG. 4 is an illustration of the personal mobility afforded by VoIP and SIP.

FIG. 5 is a call flow diagram showing the process of address resolution during a SIP VoIP call set-up.

FIG. 6 is a network architecture diagram for SIP presence as used with the present invention.

### DETAILED DESCRIPTION OF THE INVENTION

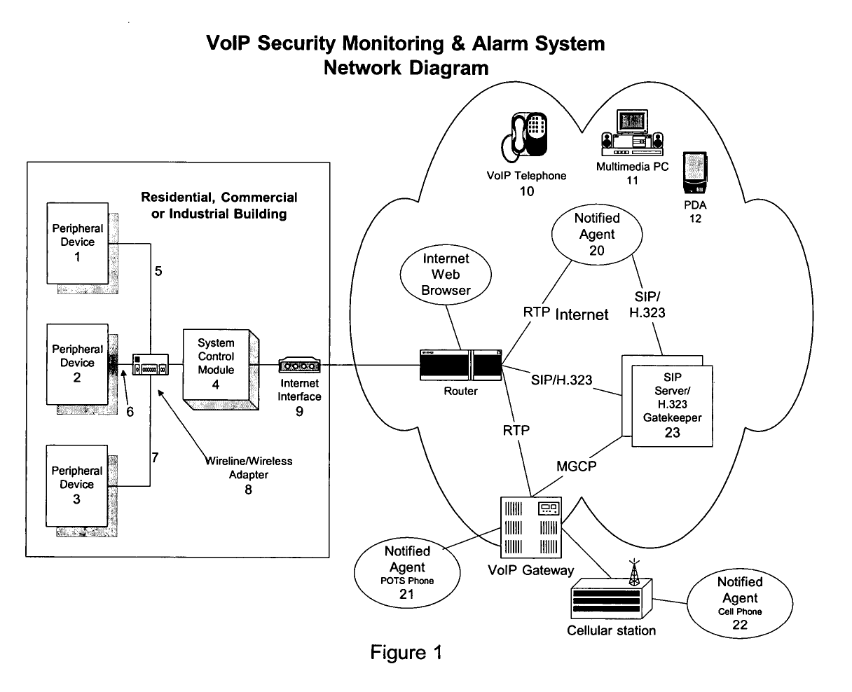

The system illustrated in FIG. 1 shows the network diagram of the VoIP Security Monitoring and Alarm System. The peripheral devices 1, 2 and 3 are situated through out the user premises at strategic exterior or interior locations, such as doors, windows, hallways or rooms. This particular drawing shows three peripheral devices, but there may be as many as 56 devices located on the premises. These devices detect an event, called the detected agent, and signal the System control module (SCM) 4 via a wireline or wireless physical interface 5, 6 and 7 respectively. If a wireline interface is used the aggregate of cables would collect in an Ethernet hub 8. If a wireless interface is used the aggregate of channels would terminate on a wireless transceiver 8. An Internet interface 9 connects the SCM 4 to the Internet. Once notified of an alarm, the SCM 4 begins the process of establishing a VoIP call with a remote user, called the notified agent, by contacting a SIP server or H.323 Gatekeeper 23 using VoIP call signalling protocols such as SIP or H.323. The notified agent can be in the IP network 20, the PSTN 21 or a cellular network 22. Typical endpoints in the IP network include a VoIP phone 10, a multimedia computer 11 or a PDA 12. Once the call is established, the peripheral device 1, 2 or 3 that is currently monitoring the detected agent sends audio data to the SCM 4. The SCM 4 then packetizes the audio data in the VoIP payload format, RTP, and forwards it to the notified agent at endpoint 20, 21, or 22 via the VoIP call leg previously established. The detected agent may change their location and move out of range of the initial peripheral device 1, 2 or 3, but into the range of an adjacent peripheral device 1, 2 or 3. This is automatically detected and the audio source data is retrieved from the new peripheral device 1, 2 or 3, without interrupting the existing call. This is the basic operation of the system.

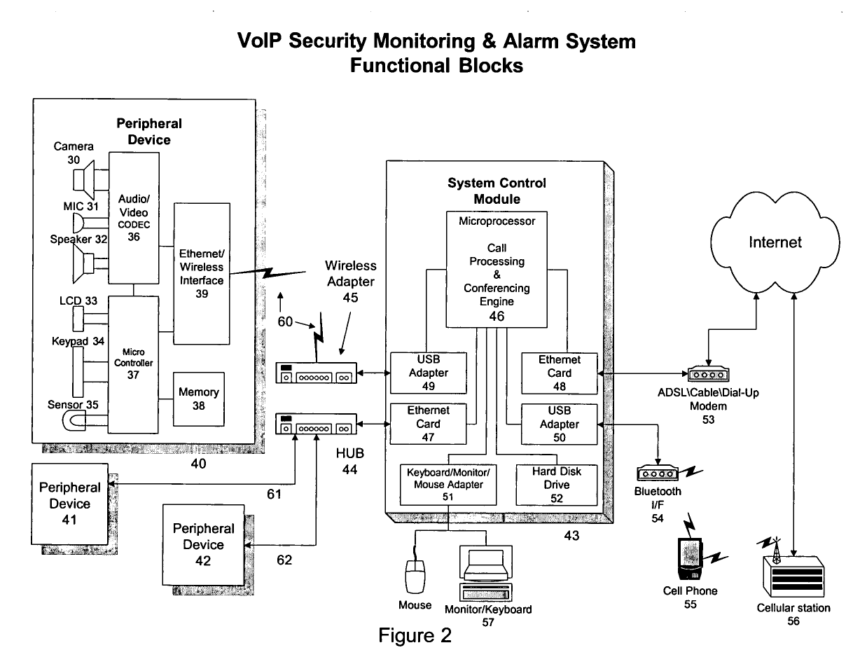

The peripheral devices will be located in various strategic locations through out the premises and as such will have different external appearances. The appearances may take on the form of the following examples but are not limited to these types. Typical enclosures include an intercom located in hallways and rooms, a doorbell-intercom located at the main entrance to the premises, and an environmentally hardened security surveillance unit that does not have intercom like features located exterior to the building. As shown in FIG. 2 the superset of peripheral device features include a camera 30, microphone 31, speaker 32, LCD 33, keypad 34, sensor 35, audio/video CODEC 36, a microcontroller 37 with attached memory 38, and an Ethernet or wireless interface 39. The electronic circuitry is on a PCB that is mounted inside a protective enclosure. The camera 30 is either a black & white or colour CCTV board camera with NTSC/PAL/SECAM outputs or a digital output when the camera has a built-in CODEC. The microphone 31 converts an acoustic signal into an electrical signal; the speaker 32 changes an electrical signal into an acoustic signal. The CODEC 36 has a video function as well as audio function. It digitizes the analog video signal into a standard digital format, codes the analog audio signal from the microphone into PCM samples, and decodes PCM samples into an analog audio signal to the speaker. The CODEC 36 also serves to perform echo cancellation to minimize the effects of acoustic echo. The LCD 33 and keypad 34 are used to provide intercom features and alarm activation/deactivation functions. With the keypad the user can enter commands to page other peripheral devices 41 or 42, or even initiate VoIP calls through the SCM 43 to an endpoint in the IP, PSTN or cellular networks. The sensor 35 may be different types, such as a motion detector, infrared radiation sensor or doorbell signal, and may be located external to the peripheral device. The signal from the sensor is routed to the microcontroller 37. The peripheral device 40 connects to the SCM 43 via an Ethernet or wireless interface 39. The channel between the peripheral devices 40, 41 or 42 and the SCM 43 may be a wireless channel 60 or wireline channel 61 or 62. The Ethernet interface 39 is 10/100BaseT and physically consists of twisted pair conductors that aggregates in a hub 44. The wireless interface 39 is either an IEEE 802.11 wireless LAN module or a Bluetooth Class 1, 2 or 3 module. The wireless channels terminate on a wireless transceiver module 45 attached to the SCM 43. The microcontroller 37 monitors and controls the on-board circuitry and interfaces with the SCM 43. It scans the keypad 34, monitors the sensor 35 and controls the LCD 33 and CODEC 36. It provides the communication interface to the SCM 43; it sends status packets to and receives control packets from the SCM 43. The status packets indicate the state of the sensor 35, keypad 34 and other on-board circuitry. The control packets from the SCM 43 configure the peripheral devices 40, 41 and 42 and serve to enable/disable the audio path through the CODEC 36 in either direction separately. Proprietary embedded software is stored on the memory 38 and runs on the microcontroller 37.

The SCM 43 is any hardware platform that runs the Windows 98, 2000, ME, XP or Linux operating system. Typically, this is an IBM compatible off the shelf computer or embedded PC with an x86 processor 46. The computer includes a minimum set of peripherals including two 10/100BaseT Ethernet cards 47 & 48, two USB ports 49 & 50, a keyboard, mouse and monitor 57 and adapter 51, and a hard disk drive 52. A connection is made between the Ethernet hub 44 and Ethernet card 47 in the PC. The wireless adapter 45 is connected to either the hub 44 or the USB Port 49. If an ADSL or Cable modem is used to attach to the Internet, this modem 53 connects to the SCM 43 via the Ethernet card 48. If a Bluetooth enabled cell phone is used to attach to the Internet then this cell phone 55 connects to the SCM 43 via the Bluetooth adapter 54 which itself connects to the SCM 43 via USB port 50. The cell phone 55 communicates with a cellular station 56. Note that the preferred method to connect to the Internet is by ADSL or Cable modem since their bandwidth capabilities are the best. This bandwidth can easily handle two way audio communication and can handle video traffic with reasonable Quality of Service (QoS). Dial-Up modems may be used for audio only applications when standard speech compressions algorithms or VoCoders are used. The hard disk drive 52 is used to record audio and video data from the peripheral devices during an alarm situation using standard formats.

The SCM runs a user software application on the operating system. This software application includes a main control algorithm for the system, the VoIP call processing engine, DTMF detection algorithm and an n-way audio conferencing engine. The main control algorithm monitors the peripheral devices and other software engines for status. It responds to events by issuing commands to the various system components. A web server also runs on the SCM that contains a user web application. The user can access this website remotely and securely using any Internet browser that supports the https protocol. The website is a graphical monitor and control program. The user can visually see the current configuration and the status of all peripheral devices. Moreover, the user can change the configuration and initiate a VoIP call to any one of the peripheral devices and can control all aspects of the system. For the website application to run on the SCM, the secured premises must use a static IP address. In the event that the IP address is not static a third-party can host the application. In this case a secure bi-directional channel will be established between the SCM and the computer hosting the web application. Status and control information will be relayed over this channel.

### DESCRIPTION OF THE PREFERRED EMBODIMENT

The present invention is intended for security monitoring and alarm systems in the residential, commercial and industrial setting. The current example illustrates how the system can be used in the residential environment, but similar set ups are used in any environment.

The preferred method of deploying the system is by using the wireless method of connecting the peripheral devices and system control module. This is especially true if the system is being installed in a home that is already built and containing no ‘roughed in’ wiring for such a system.

Peripheral devices with varying functionality can be chosen and installed simultaneously, such as intercoms, doorbell-intercoms or surveillance units. The peripheral devices are mounted around the home on the exterior and interior at strategic locations. The exterior locations are chosen so the devices monitor entrances to the building such as doors and windows. The inside positions are chosen such that the devices are conveniently located for intercom use while at the same time serving to monitor rooms and hallways. The system control module can be conveniently located anywhere in the home. The best location is usually near the Internet access modem (ADSL/Cable). Note that the premises must have a means of connecting to the Internet.

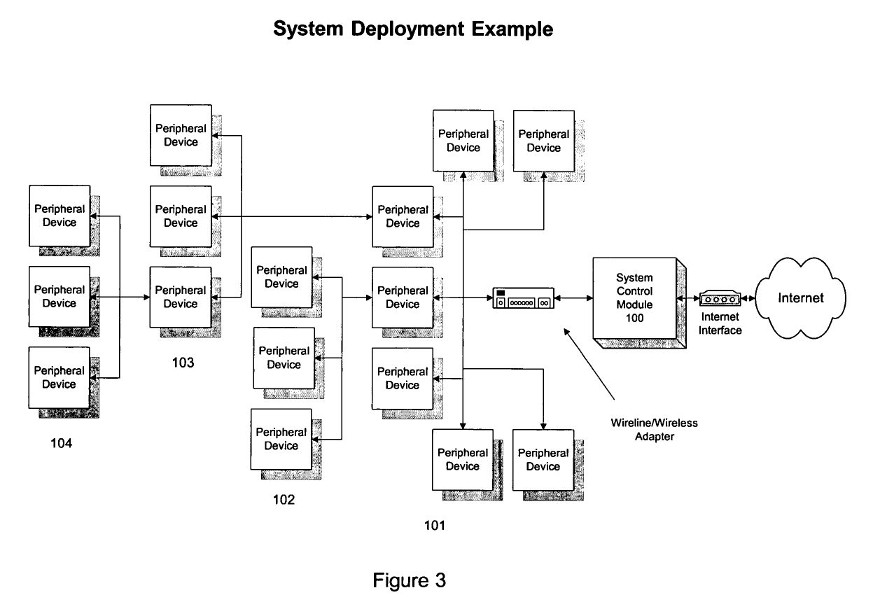

Once the peripheral devices and controller are deployed the system can be powered on. Immediately the wireless modules in the system control module and each peripheral device begin to discover what other devices are in their environment. This is the discovery period of initialization. After this phase is complete there is a network called a ‘scatternet’. The network topology of a scatternet is shown in FIG. 3. The system control module 100 is the first master device in a chain of master-slave device relationships. The system control module communicates with the first tier of slave devices 101, up to seven in total. Each slave device in the first tier can communicate with up to 7 devices as well, and so on and so on. A 2^{nd} order tier 102 is shown in FIG. 3, as well as a 3^{rd} order tier 103 and 4^{th} order tier 104. The depth of master/slave device relationships and the total number of devices is bandwidth limited.

On the SCM the user application and web server start automatically when the system control module is powered on. The embedded software on the peripheral devices also starts automatically when the peripheral device is powered on.

The next step is to set up the configurable parameters of the system. This is done at the system control module using a keyboard and monitor. These parameters include items such as access codes, the VoIP addresses (URLs) to call during alarm, pre-recorded messages and zone definitions among others. The set-up also includes configuring the system management portal web application. Once the system is configured the user may access this secure portal remotely via any Internet enabled device equipped with a web browser.

Once configuration is complete the system is now ready to be used. The SCM sends command packets to and receives status packets from the peripheral devices. It polls each peripheral device to verify availability and operational correctness. The SCM also sends status packets to and receives request packets from an off premises third party monitoring service. This polling is done to verify availability of the security system to the Internet.

There are two different operating modes for the system: Normal and Armed. The current operating mode can be selected at any peripheral device with a keypad, at the SCM using the keyboard and monitor, remotely with an Internet browser via the system management portal or by calling into the SCM and issuing DTMF commands. Both the peripheral devices and SCM behave differently depending on the operating mode.

In the Normal mode, the peripheral devices function as intercoms and doorbells. They can be used to page people in the house, place outgoing or answer incoming VoIP calls and notify that someone is at the door. They still notify the SCM when an event like motion, infrared radiation or vibration detection takes place. A novel feature of this invention is the ability to establish multiple simultaneous VoIP calls. In this case, each call is between a peripheral device and a remote endpoint in the Internet, PSTN or cellular network. This is useful for a family or household with many active callers.

In Armed mode the peripheral devices function to monitor the environment and notify the SCM when said events take place. The intercom and outgoing call functionality is disabled in all peripheral devices. The doorbell in appearance functions as normal, but in addition to notifying people locally with a chime when pressed, it also places a call to a pre-configured VoIP address. The notified agent can talk to the visitor as if they are still within their home.

The SCM functionality is essentially the same in the two modes, except that it is blocked from generating outbound alarms in Normal mode. In Alarm Mode the SCM will generate an outbound call when a peripheral device notifies it of an event or when it loses communication with any one of the peripheral devices.

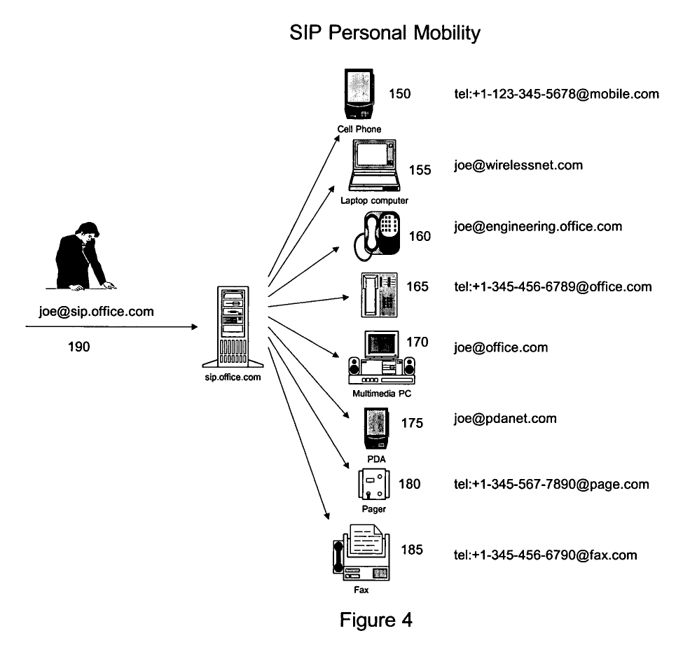

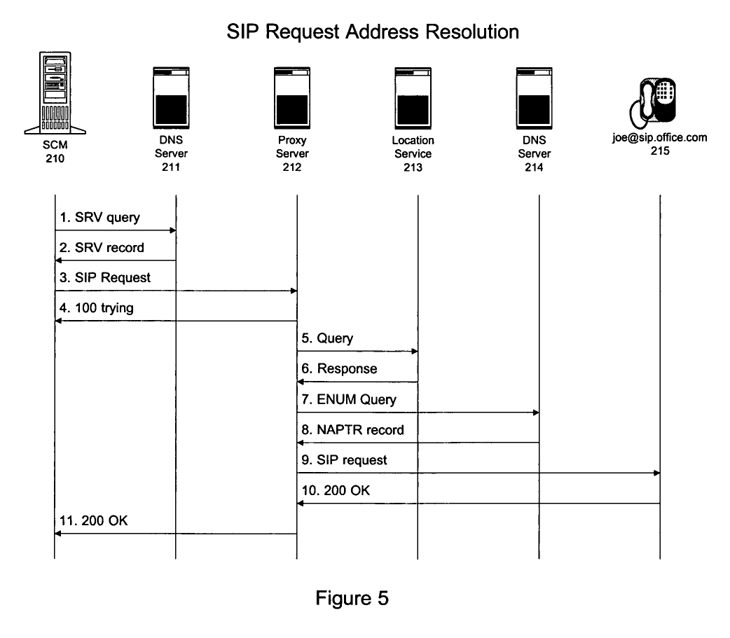

During an alarm a remote user receives some form of VoIP notification. FIG. 4 illustrates several devices that a user may use for communication to receive this notification: a cell phone 150, a laptop computer 155, a VoIP phone 160, a POTS phone 165, a multimedia computer 170, a PDA 175, a pager 180 and a FAX 185. When the security system attempts to establish a VoIP call it uses a generic URL, joe@sip.office.com 190 to reach the user. The SCM needs to know which particular device the user can be reached on. A feature called ‘presence’, described subsequently, can be used to make this determination. First, the SIP address resolution process during call set-up shown in FIG. 5 is discussed. This call set-up is a simplified version of what may exist in the network. The SCM 210 wishes to make a call to the user at joe@sip.office.com. When the SCM 210 starts the call establishment process, it performs a DNS SRV 211 query to locate the proxy server 212 for the sip.office.com domain in steps 1 and 2. The SIP request is then sent to the IP address of this proxy server 212 in step 3. The proxy then consults a location service 213 in step 5, which locates the current registration URL for joe. The proxy 212 then sends an ENUM DNS query in step 7 to DNS server 214 to find the corresponding IP address 215, which is returned and used in the SIP request in step 9. The request is then routed to joe at that IP address 215, who returns a successful SIP response 200 OK in step 10 to the proxy server 212. The proxy server forwards the success response 200 OK in step 11 back to the SCM 210. Now the call is established.

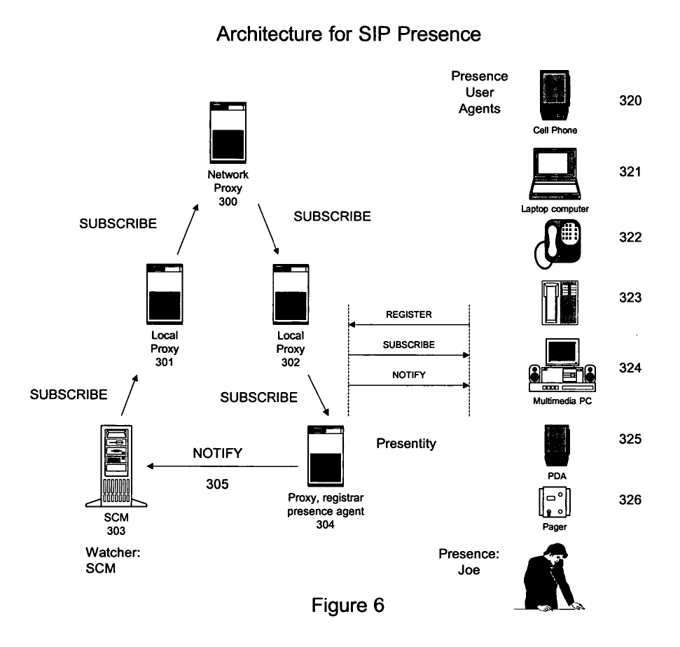

The above example illustrates the address resolution process for the situation where the user has only a single device. What if the user has several devices, as shown in FIG. 4, and still only one generic URL, joe@sip.office.com? The VoIP feature called presence can be used by the SCM to determine which particular device to contact. Presence services are a new form of communication possible due to the datagram nature of the Internet. Presence can provide information about various attributes such as: presence on the net, location (office, home, visit, travel), call state (ready, on another call), willingness (available, in meeting), preferred medium (text, voice, video, email) and personal preferences. FIG. 6 illustrates the SIP presence architecture in relation to the present invention. The presence agent server 304 for the principal, Joe, on the right side of FIG. 6 may convey presence for many devices (320, 321, 322, 323, 324, 325, 326) as shown. Connectivity to the network by any device is logged in the SIP proxy registrar and presence agent server 304 on a dynamic basis. The SCM 303, who is a watcher on the left, can find the presence information for Joe by having the SUBSCRIBE message forwarded by the SIP proxies 300, 301 and 302 in the network to the SIP proxy registrar 304 for all the devices that Joe may have. The presence agent server 304 can accept SUBSCRIBE requests on its own or forward the request to any of the active devices, so that Joe can make the decision to accept or reject the SCM 303 as a new watcher. SIP user preferences can determine to which of several possible devices the SUBSCRIBE message should be routed. NOTIFY messages 305 can then be sent directly from the ‘presentity’ user agent on one of the devices owned by Joe to the watcher, the SCM 303. These messages indicate the presence of the user on a particular device. During alarm, the SCM knows beforehand which device to contact (work phone, cell, laptop) and what method of message to send (text, voice, video, email). If the SCM determines that it should reach the laptop with an instant message then a text message will be routed in real-time to the laptop computer. The remote user can then send back a text message commanding the SCM to make an audio and video call to the same device, or perhaps a different device.

When the audio call is established, the remote user will initially hear the ambient audio from the peripheral device in the location the event took place that generated the alarm. The user can issue commands to the SCM by using a keypad to send DTMF tones. A DTMF detection algorithm on the SCM processes the packets coming from the remote user and detects any DTMF tones. The control algorithm then processes the detected tones to perform a specific action requested by the user. Several commands are available to the user, some of which are described below.

The remote user can enable audio to be sent from his location to the peripheral device currently sourcing the ambient audio. The remote user can increase and decrease the volume of the audio path. The remote user can direct the SCM to play an announcement over the speaker at the peripheral device currently sourcing ambient audio.

The remote user can initiate a conference call to a third-party, such as his neighbour or the police. After the first VoIP call is established the user can send a DTMF command to the SCM to initiate a conference call. The SCM then begins the VoIP call signalling protocol to invite another party into the existing call. For n-way audio conferencing there needs to be a audio processing algorithm, called a conferencing bridge, that receives all the transmit audio streams, mixes them and sends them back as receive audio streams to their respective sources. This algorithm can run on the SCM or on a third-party conferencing service in the IP network.

As a last example of intended use, the present invention allows multiple VoIP calls to be established to remote endpoints in the Internet, PSTN or cellular networks. This functionality is provided when the system is unarmed, hence not providing alarm notification to a remote user. In this mode the system is free to set-up VoIP calls from any peripheral device with a keypad and LCD to a remote endpoint. The number of simultaneous calls is limited by the bandwidth provided by the wireline or wireless communications interface means between the peripheral devices and system control module. If Bluetooth wireless communications means are used for this interface, then the system can support up to three simultaneous VoIP calls.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for notifying a remote person or computer server of an alarm event or intrusion by establishing a voice and/or video communication call between the location of the event and the location of the person or computer server by using Voice over Internet Protocols (VoIP), comprising:
(a) providing an event detection means that detects the event to be notified of,
(b) providing a peripheral device means to receive voice and/or video information from and transmit voice and/or video information to the area the event took place,
(c) providing a computing platform means that operates as a system control module running a control program,
(d) providing a means to connect the said computing platform means to the Internet,
(e) providing an event detection interconnection means to connect the said event detection means to the said computing platform means to exchange control and data information,
(f) providing a peripheral device interconnection means to connect the said peripheral device means to the said computing platform means to exchange control and data information,
whereby the said computing platform detects an event from the said event detection means using the said event detection interconnection means, and
whereby the said computing platform upon event detection establishes a Voice over Internet Protocol (VoIP) communication call such that voice and/or video information is exchanged between the said peripheral device means and the said computing platform means using the said peripheral device interconnection means, and between the said computing platform means and the remote person or server using the said Internet connection means.

2. An alarm monitoring and notification apparatus for notifying a remote person or computer server of an alarm event or intrusion by establishing a voice and/or video communication call between the location of the event and the location of the person or computer server by using Voice over Internet Protocols (VoIP), comprising:
(a) an event detection means that detects the event to be notified of,
(b) a peripheral device means to receive voice and/or video information from and transmit voice and/or video information to the area the event took place,
(c) a computing platform means that operates as a system control module running a control program,
(d) a means to connect the said computing platform means to the Internet,
(e) an event detection interconnection means to connect the said event detection means to the said computing platform means to exchange control and data information,
(f) a peripheral device interconnection means to connect the said peripheral device means to the said computing platform means to exchange control and data information,
whereby the said computing platform detects an event from the said event detection means, and
whereby the said computing platform upon event detection establishes a Voice over Internet Protocol (VoIP) communication call such that voice and/or video information is exchanged between the said peripheral device means and the said computing platform means using the said peripheral device interconnection means and between the said computing platform means and the remote person or server using the said Internet connection means.

3. The method for notifying a remote person or computer server of claim 1 wherein the Voice over Internet Protocol (VoIP) used to establish, modify and terminate the voice and/or video communication call is the Session Initiation Protocol (SIP) developed by the Internet Engineering Task Force.

4. The method for notifying a remote person or computer server of claim 1 wherein the Voice over Internet Protocol (VoIP) used to deliver voice and/or video information between the said computing platform and remote person or server is the Real-Time Transport Protocol (RTP) developed by the Internet Engineering Task Force.

5. The method for notifying a remote person or computer server of claim 1 wherein the Presence feature of the Session Initiation Protocol is used to identify the remote person's location in real-time for the purpose of establishing the Voice over Internet Protocol communication call to the device the remote person prefers.

6. The method for notifying a remote person or computer server of claim 1 wherein the remote person or server can be notified of the event by the Instant Messaging feature of the Session Initiation Protocol.

7. The method for notifying a remote person or computer server of claim 1 wherein the remote person can initiate a conference call by sending Dual Tone Multi Frequency (DTMF) digits to the control program on said computing platform for the purpose of initiating another Voice over Internet Protocol communication call to another party.

8. The method for notifying a remote person or computer server of claim 1 wherein the Voice over Internet Protocol (VoIP) communication call terminates in the Internet domain, or the Public Switched Telephone Network domain, or the Cellular domain.

9. The method for notifying a remote person or computer server of claim 1 wherein a Web portal application is used to control the said computing platform means and control program so that a person can control and monitor the alarm system remotely over the Internet.

10. The alarm monitoring and notification apparatus of claim 2 wherein the said peripheral device interconnection means is the Bluetooth wireless standard.

11. The alarm monitoring and notification apparatus of claim 2 wherein said means of connecting said computing platform to the Internet includes Digital Subscriber Line (DSL) modem, Cable modem or Cellular modem.

12. The alarm monitoring and notification apparatus of claim 2 wherein the said peripheral device operates as an Intercom device.

13. The alarm monitoring and notification apparatus of claim 2 wherein the said peripheral device operates as a doorbell Intercom device.

14. The alarm monitoring and notification apparatus of claim 2 wherein the said peripheral device operates as an audio only device, or a video device only, or an audio and video device only, or any of these combinations with the event detection means as well.
